(19) United States
(12) Patent Application Publication
(10) Pub. No.: US 2012/0046908 A1
(43) Pub. Date: Feb. 23, 2012

(54) PORTABLE LOAD SCALE SYSTEMS

(75) Inventors: Sidney Ray Campbell, Sherwood, OR (US); Andrew Thorpe Mount, Portland, OR (US); Kristopher Lawrence Hett, Portland, OR (US)

(73) Assignee: RIGHT WEIGH, INC., Sherwood, OR (US)

(21) Appl. No.: 13/215,832

(22) Filed: Aug. 23, 2011

Related U.S. Application Data
(60) Provisional application No. 61/402,100, filed on Aug. 23, 2010.

(30) Foreign Application Priority Data
Aug. 26, 2010 (AU) 2010903831
Aug. 26, 2010 (NZ) 587596

(51) Int. Cl. G01G 19/10; G06F 15/00

(52) U.S. Cl. 702/174

(57) ABSTRACT

Devices and methods of measuring a loaded weight of a vehicle are disclosed. The device may include a sensor assembly configured to detect pressure in the at least one air spring. The device may additionally include a solenoid valve assembly disposed between the sensor assembly and the at least one air spring and configured, when the sensor assembly is not detecting the pressure, to isolate the sensor assembly from the pressure in the at least one air spring while not isolating the at least one air spring from the pressure source. The device may further include a processor assembly configured to calculate a loaded weight of the vehicle based on the detected pressure, and a display assembly configured to display the calculated loaded weight.

### CROSS-REFERENCE TO RELATED APPLICATIONS

This application claims priority under 35 U.S.C. §119(e) to U.S. Provisional Patent Application Ser. No. 61/402,100 entitled “Portable Load Scale Systems,” filed Aug. 23, 2010. Additionally, this application claims priority under 35 U.S.C. §119(a)-(d) to Australian Provisional Patent Application No. 2010903831 entitled “Portable Load Scale Systems,” filed Aug. 26, 2010. Finally, this application claims priority under 35 U.S.C. §119(a)-(d) to New Zealand Provisional Patent Application No. 587596 entitled “Portable Load Scale Systems,” filed Aug. 26, 2010. The complete disclosures of the above applications are hereby incorporated by reference for all purposes.

### BACKGROUND OF THE DISCLOSURE

Hauling freight and cargo by truck and tractor-trailer is a vital part of the commercial infrastructure of many nations. Operators of such vehicles need to efficiently and safely load their vehicles, while complying with weight regulations. While fixed-location commercial weigh stations are available, those stations provide information distant in time and space from where the truck was loaded, resulting in delays and potential citations if the vehicle does not conform to regulatory requirements.

Examples of weight measurement devices and/or load scale systems, including portable weight measurement devices and/or portable load scale systems, are disclosed in U.S. Pat. Nos. 3,331,458; 4,588,038; 4,651,838; 4,789,033; 4,832,141; 5,016,200; 5,086,656; 5,119,895; 5,167,289; 5,478,974; 5,780,783; 6,803,530; 7,572,988; 7,612,303; 7,705,715; and U.S. Patent Application Publication No. 2001/0009206. The complete disclosures of the above patents and patent application publication are hereby incorporated by reference for all purposes.

### SUMMARY OF THE DISCLOSURE

The present disclosure is directed to a portable load scale device for a vehicle. The vehicle may include a frame, a wheel axle assembly, a pressure source, and at least one air spring disposed between the frame and the wheel axle assembly and pressurized by the pressure source. The device may, in some examples, include a sensor assembly configured to detect pressure in the at least one air spring. The device may additionally include a solenoid valve assembly disposed between the sensor assembly and the at least one air spring and configured, when the sensor assembly is not detecting the pressure, to isolate the sensor assembly from the pressure in the at least one air spring while not isolating the at least one air spring from the pressure source. The device may further include a processor assembly configured to calculate a loaded weight of the vehicle based on the detected pressure, and a display assembly configured to display the calculated loaded weight.

The device may, in some examples, include a housing configured to be removably mounted to the frame, and a sensor assembly contained within the housing and configured to detect pressure in the at least one air spring. The device may additionally include a solenoid valve assembly contained within the housing and disposed between the sensor assembly and the at least one air spring, the solenoid valve assembly being configured, when the sensor assembly is not detecting the pressure, to isolate the sensor assembly from the pressure in the at least one air spring. The device may further include a processor assembly contained within the housing and configured to calculate a loaded weight of the vehicle based on the detected pressure, and a display assembly configured to display the calculated load weight.

The present disclosure is also directed to a method of measuring a loaded weight of a vehicle. The vehicle may include a frame, a wheel axle assembly, a pressure source, and at least one air spring disposed between the frame and the wheel axle assembly and pressurized by the pressure source. The method may, in some examples, include detecting pressure in the at least one air spring via a sensor assembly of a portable load scale device, and calculating loaded weight of the vehicle based on the detected pressure. The method may additionally include displaying the calculated loaded weight. The method may further include isolating the sensor assembly from the pressure in the at least one air spring when not detecting the pressure in the at least one air spring, while not isolating the at least one air spring from the pressure source.

### BRIEF DESCRIPTION OF DRAWINGS

FIG. 1 is a side view of a vehicle with an example of a portable load scale system connected to an air suspension system of a vehicle.

FIG. 2 is an isometric view of an example of an air suspension system of the vehicle of FIG. 1 with the portable load scale system of FIG. 1.

FIG. 3 is a block diagram of an example of the portable load scale device of the portable load scale system of FIG. 1.

FIG. 4 is an electrical schematic of an example of a power supply assembly of the portable load scale device of FIG. 3.

FIG. 5 is an electrical schematic of an example of a display assembly of the portable load scale device of FIG. 3.

FIG. 6 is an electrical schematic of an example of a backlight assembly of the display assembly of FIG. 5.

FIG. 7 is an electrical schematic of an example of a sensor assembly of the portable load scale device of FIG. 3.

FIG. 8 is an electrical schematic of an example of a system controller assembly of the portable load scale device of FIG. 3.

FIG. 9 is an electrical schematic of an example of a solenoid control assembly of the portable load scale device of FIG. 3.

FIG. 10 is an electrical schematic of another example of a power supply assembly of the portable load scale device of FIG. 3.

FIG. 11 is an electrical schematic of another example of a solenoid control assembly of the portable load scale device of FIG. 3.

FIG. 12 is a front view of an example of a portable load scale device of FIG. 3.

FIG. 13 is an isometric view of an example of a protective box for the portable load scale device of FIG. 12.

### DETAILED DESCRIPTION OF THE DISCLOSURE

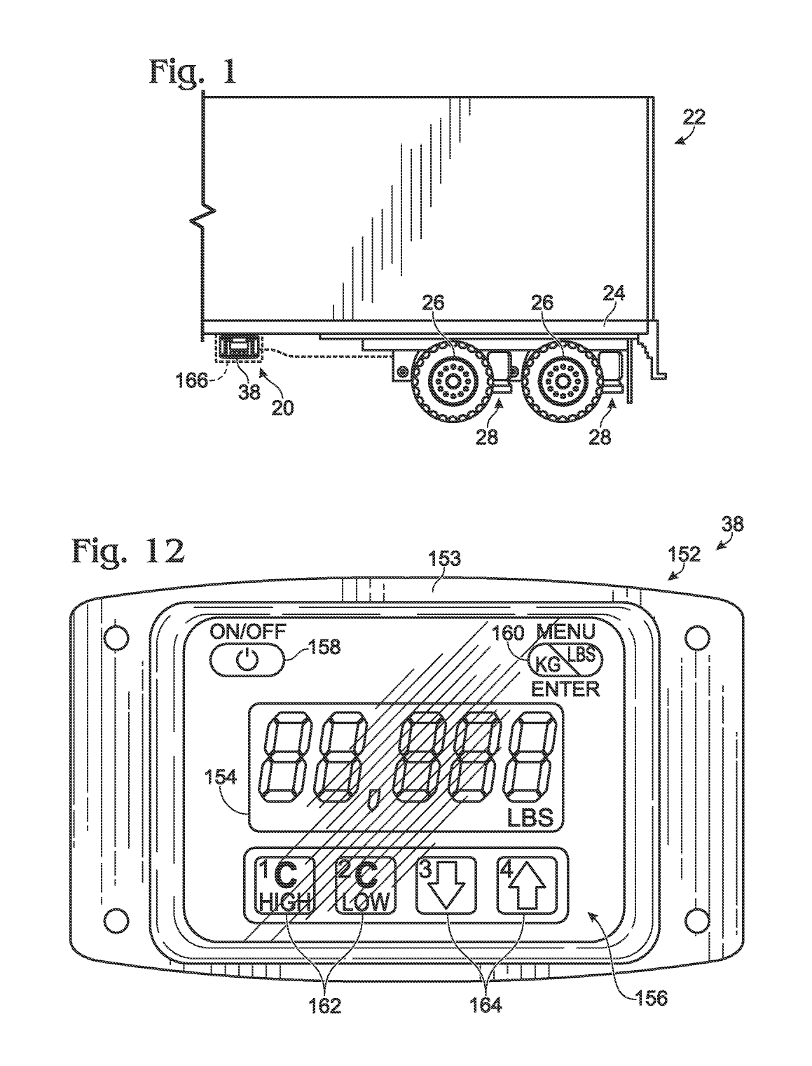

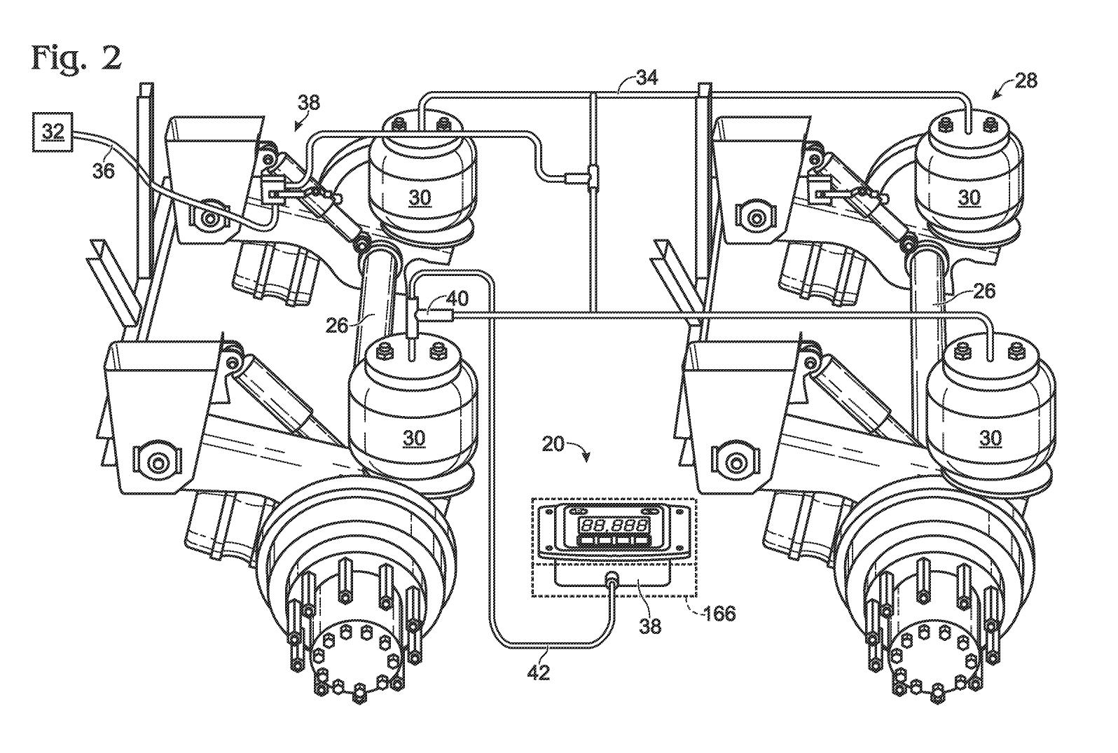

FIGS. 1-2 show an example of a portable load scale system 20 for a vehicle 22. Vehicle 22 may include a frame 24, a wheel axle assembly 26, and an air suspension system 28. The air suspension system may include one or more air bags or air springs 30, a pressure source 32, an air spring manifold 34, a source conduit 36, and a height control valve 38, as shown in FIG. 2. The air springs may be disposed between the frame and wheel axle assembly and pressurized by the pressure source. The air spring manifold may fluidly connect air springs 30 together. Source conduit 36 may fluidly connect pressure source 32 with air spring manifold 34. Height control valve 36 may be actuated by the vehicle's control system (not shown) or a user to control the amount of pressure in the air springs. Although vehicle 22 is shown to be a trailer, the vehicle may be any suitable powered and/or unpowered vehicles that include an air suspension system, such as trucks and/or other trailers.

Portable load scale system 20 may include any suitable structure configured to determine the loaded weight of vehicle 22. For example, the portable load scale system may include a portable load scale device 38, as shown in FIGS. 1-2. Additionally, portable load scale system 20 may include any suitable structure configured to fluidly connect portable load scale device 38 to air suspension system 28. For example, the portable load scale system may include a t-fitting 40 (such as a street tee) and tubing 42, as shown in FIG. 2. The tubing may be received in tubing connector(s) (not shown) of the portable load scale device. Two or more t-fittings 40 and tubing 42 may be used to connect to different portions (or the same portion) of the air suspension system. For example, a first tubing 42 may be used to connect to a first sensor of the portable load scale device, while a second tubing 42 may be used to connect to a second sensor of the portable load scale device. The first and second tubing may be connected to first and second air spring(s) 30 (or first and second air spring manifolds 34) or the same air spring 30 or same air spring manifold 34. Although portable load scale system 20 is shown to include t-fitting 40 and tubing 42, the portable load scale system may include any suitable structure configured to connect the portable load scale device to the air suspension system of the vehicle.

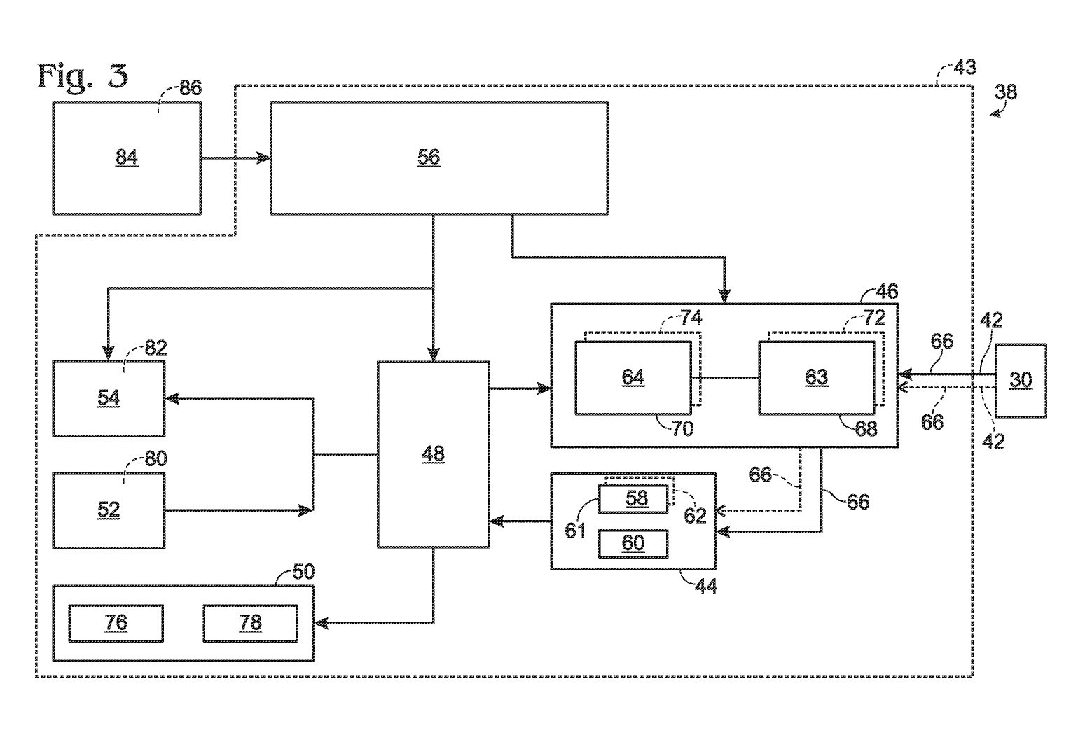

Portable load scale device 38 may include any suitable structure configured to calculate and display the loaded weight of vehicle 22. For example, portable load scale device may include a housing 43, a sensor assembly 44, a solenoid valve assembly 46, a processor assembly 48, a memory assembly 50, an input assembly 52, an output assembly 54, and a power supply assembly 56, as shown in FIG. 3.

Housing 43 may be configured to be removably mounted to frame 24 and/or to at least partially contain one or more other components of the portable load scale device. For example, housing 43 may partially or fully contain sensor assembly 44, solenoid valve assembly 46, processor assembly 48, memory assembly 50, input assembly 52, output assembly 54, and/or power supply assembly 56. Alternatively, one or more of the above assemblies may be partially or fully outside of the housing. For example, input assembly 52 and/or output assembly 54 may be located outside of housing 43, such as on or inside the vehicle's dashboard or instrument panel. Housing 43 may be made of one or more hard plastic material(s) and may be any suitable color(s).

Sensor assembly 44 may include any suitable structure configured to detect pressure in air spring(s) 30. For example, the sensor assembly may include at least one sensor 58 and a sensor processor 60, as shown in FIG. 3. Sensor assembly 44 may include any suitable number of sensors 58, such as one, two, three, four, five, or more sensors, which may be connected to any suitable portions of the air suspension system(s) of vehicle 22. For example, the sensor assembly may include a first sensor 61 and a second sensor 62. The first sensor may be fluidly connected to a first air spring or first air spring manifold, while the second sensor may be fluidly connected to a second air spring or second air spring manifold different from the first air spring or first air spring manifold (such as separate air manifolds for a truck and/or trailer). The first and second sensors may alternatively be fluidly connected to the same air spring or same air spring manifold. Alternatively, the sensor assembly may include a single sensor 58.

Sensor 58 may include one or more piezo-resistive, capacitive, electromagnetic, piezoelectric, optical, potentiometric, resonant, and/or thermal sensors. For example, sensor 58 may include at least one piezo-resistive sensor that may be configured to sense or detect the pressure in air spring(s) 30 and produce analog output voltage(s). Sensor processor 60 may be configured to convert the analog output voltage(s) from sensor 58 into digital value(s) for processor assembly 48, such as sixteen-bit digital signals.

Solenoid valve assembly 46 may include any suitable structure disposed between sensor assembly 44 and air spring(s) 30 and/or configured to isolate sensor assembly 44 from pressure in the air spring(s). The solenoid valve assembly may isolate the sensor assembly at any suitable time(s) and/or operational step(s) of the portable load scale device. For example, solenoid valve assembly 46 may be configured to isolate sensor assembly 44 from pressure in air springs(s) 30 when the sensor assembly is not detecting the pressure in the air spring(s) and/or when the portable load scale device is not in operation or powered off, such as via input assembly 52. In some embodiments, the solenoid valve assembly may isolate sensor assembly 44 from pressure in air spring(s) 30 while not isolating the air springs from pressure source 32.

Solenoid valve assembly 46 may, for example, include at least one air valve 63 and at least one solenoid 64, as shown in FIG. 3. The air valve may be disposed between the sensor assembly and the air spring(s), such as in one or more conduit(s) 66 that fluidly connect the sensor assembly to tubing 42, which may be fluidly connected to the air spring(s) or air spring manifold(s). Air valve 63 may be any suitable mechanical, hydraulic, pneumatic, and/or other suitable valve that may be operated by solenoid 64. Solenoid 64 may be operatively connected to the air valve to move the air valve among a plurality of positions, such as an open position in which the sensor assembly is in fluid communication (or is fluidly connected) with the air spring(s), and a closed position in which the sensor assembly is isolated from (or is fluidly disconnected) from the air spring(s).

In some embodiments, sensor assembly 44 may be fluidly connected to (or in fluid communication with) air spring(s) 30 and/or air spring manifold(s) 34 via conduit(s) 66 within housing 43 and tubing 42 that is external to housing 43, as shown in FIGS. 2-3. Solenoid valve assembly 46 may be disposed between the sensor assembly and the air spring(s) and/or air spring manifold(s) within housing 43. For example, the solenoid valve assembly may divide conduit(s) 66 into a first portion between the sensor assembly and the solenoid valve assembly, and a second portion between the solenoid valve assembly and tubing 42.

Solenoid valve assembly 46 may include air valve(s) 63 disposed within the conduit(s) to regulate flow within the conduit(s). For example, when air valve(s) 63 is in the open position, air (or another gas or fluid) from the air spring(s) and/or air spring manifold(s) may flow through the solenoid valve assembly and into the sensor assembly to allow the sensor assembly to detect the pressure in the air spring(s) and/or air spring manifold(s). Alternatively, when air valve(s) 63 is in the closed position, air from the air spring(s) may flow only to the solenoid valve assembly and does not flow past the solenoid valve assembly and into the sensor assembly. In that position, the sensor assembly and/or portion of conduit(s) 66 between the solenoid valve assembly and the sensor assembly may isolated from the pressure in the air spring(s) and/or air spring manifold(s) because the air does not flow past the solenoid valve assembly and into the sensor assembly for the sensor assembly to detect that pressure. The portable load scale device may include one or more exhaust vents or systems (not shown) in any suitable portion(s) of the device to allow for pressure to be vented between pressure readings.

The solenoid valve assembly may include any suitable number of air valves 63 and solenoids 64, such as one, two, three, four, or more air valves and solenoids. For example, solenoid valve assembly 46 may include a first air valve 68 and a first solenoid 70 operatively connected to the first air valve to move the first air valve between open and closed positions, and a second air valve 72 and a second solenoid 74 operatively connected to the second air valve to move the second air valve between open and closed positions. The first air valve may be disposed in conduit 66 and/or between sensor assembly 44 and a first air spring or first air spring manifold, while the second air valve may be disposed in conduit 66 and/or between the sensor assembly and a second air spring or second air spring manifold different from the first air spring or first air spring manifold. Alternatively, the first and second air valves may be disposed in conduit 66 and/or between the sensor assembly and the same air spring or air spring manifold.

Processor assembly 48 may include any suitable structure configured to calculate a loaded weight of vehicle 22 based on the detected pressure in air spring(s) 30 and/or air spring manifold 34. For example, processor assembly 48 may calculate loaded weight of the vehicle based on detected pressure from a single sensor, first and second sensors, and/or any suitable combination of sensors. When sensor assembly 44 includes multiple sensors, the processor assembly may calculate loaded weight(s) based on pressure detected by each or one or more of the sensors and/or calculate an average loaded weight based on pressure detected by those sensors. For example, the processor assembly may be configured to calculate a first loaded weight based on the pressure detected by a first sensor, a second loaded weight based on the pressure detected by a second sensor, and/or an average loaded weight based on the first and second loaded weights.

Additionally, or alternatively, the processor assembly may control solenoid valve assembly 46, store and/or read data from memory assembly 50, receive input from input assembly 52, and provide output to output assembly 54. For example, processor assembly may control solenoid(s) 64 to move air valve(s) 63 between an open position, such as when the sensor assembly is detecting the pressure in the air spring(s) or when the portable load scale device is powered on, and a closed position, such as when the sensor assembly is not detecting the pressure in the air spring(s) or when the portable load scale device is powered off.

Memory assembly 50 may include any suitable structure configured to store any suitable data, such as calibration data, detected pressure data, pressure-to-weight data, and/or calculated load weight data. For example, as shown in FIG. 3, the memory assembly may include memory 76 and/or persistent storage 78, which may be any suitable hardware configured to store information or data on a permanent and/or temporary basis. Memory 76 may, for example, include random access memory and/or any suitable volatile and/or non-volatile device. Persistent storage 78 may, for example, include a hard drive, flash memory, a rewritable optical disk, and/or rewritable magnetic disk. Although memory assembly 50 is shown to include both memory 76 and persistent storage 78, the memory assembly may include only memory 76 or only persistent storage 78.

Input assembly 52 may include any suitable structure configured to receive input from a user of the portable load scale device. For example, the input assembly may include a keypad 80, as shown in FIG. 3. Alternatively, or additionally, input assembly 52 may include a mouse, a keyboard, a touch-sensitive screen, a microphone or voice control system, a camera or optical control system, and/or other suitable input devices.

Output assembly 54 may include any suitable structure configured to convey output to a user of the portable load scale device. For example, as shown in FIG. 3, the output assembly 54 may include a display 82, such as an LED or LCD display. When output assembly 54 includes a display, the output assembly may sometimes be referred to as a “display assembly.” Alternatively, or additionally, output assembly 54 may include a graphical user interface, lights, and/or a speaker.

Power supply assembly 56 may include any suitable structure configured to receive power from a power source 84 and provide at least some of that power to one or more other components of the portable load scale device, such as solenoid valve assembly 46, processor assembly 48, and/or output assembly 54. The power supply assembly may, for example provide power in a first voltage (such as about 12 or about 24 volts) to the solenoid valve assembly, and to provide power in a second voltage different from the first voltage (such as about 3.3 volts) to the processor assembly and/or the output assembly. The power supply assembly also may be configured to provide noise filtering, load dump protection, reverse power protections, and/or other suitable functions. The power source may be any suitable source of power, such as a battery 86 of vehicle 22. For example, the power supply assembly may be electrically connected to the vehicle's electrical system. Alternatively, or additionally, power source 84 may include one or more other suitable batteries, solar power, wind power, and/or other suitable power sources.

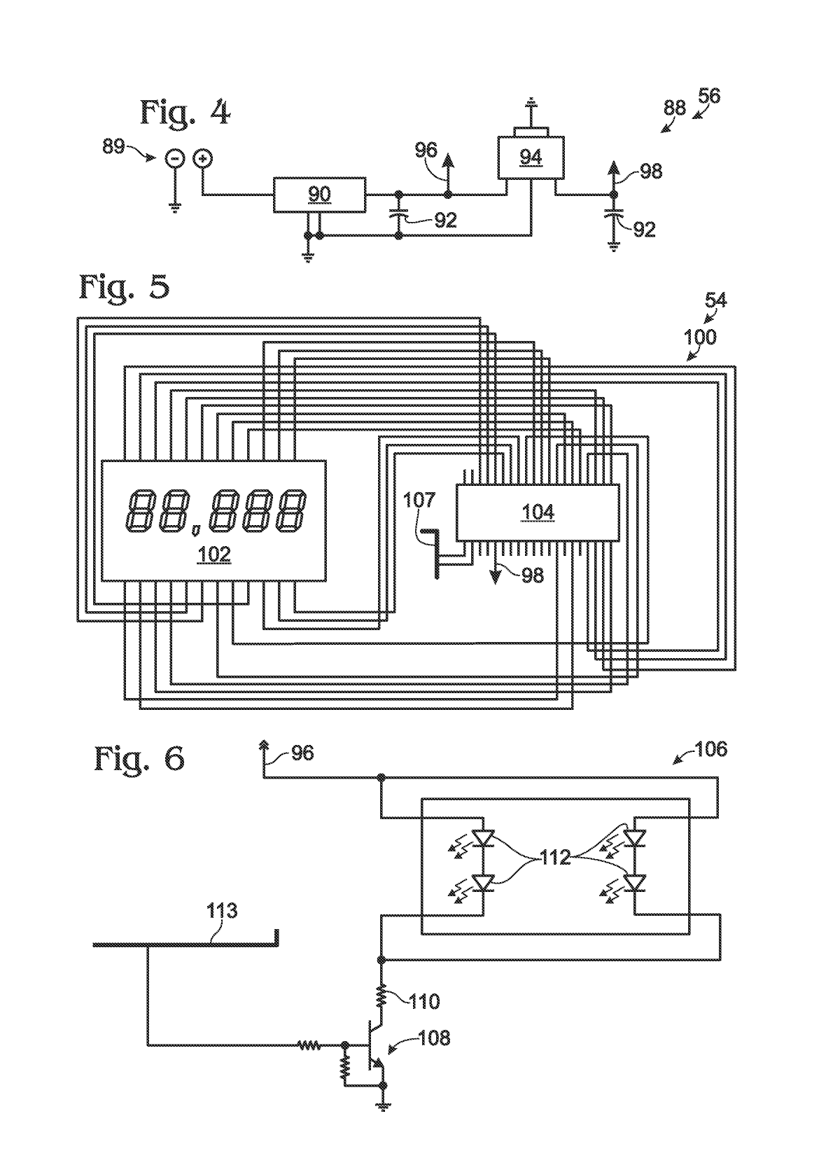

FIGS. 4-9 show electrical schematics of an example of a portable load scale device 38. FIG. 4 shows an example of a power supply assembly 56, which is generally indicated at 88. Unless specifically excluded, power supply assembly 88 may include one or more components and/or functions of one or more other power supply assemblies described in this disclosure. Power supply assembly 88 may include, power input connectors 89, a power supply processor 90, filter capacitors 92, and a voltage regulator 94. The power supply processor may include a low dropout regulator that may be configured, for example, for noise filtering, load dump protection, and/or reverse power protection. Voltage regulator 94 may regulate received voltage to one or more other voltages. Power supply assembly 88 may provide any suitable combination of regulated and unregulated voltages, such as unregulated voltage line(s) 96 (which may have the voltage(s) received from power input connectors 89) and regulated voltage line 98 (which may have voltage(s) different from the voltage(s) received from the power input connectors).

FIGS. 5-6 show an example of an output assembly 54, which is generally indicated at 100. Unless specifically excluded, output assembly 100 may include one or more components and/or functions of one or more other output assemblies described in this disclosure. Output assembly 100 may include an LCD display 102, a display controller 104, and a backlight assembly 106 for the LCD display. Display controller 104 may be connected to an LCD display bus 107 that is connected to the processor assembly. The backlight assembly may include an on/off control 108, at least one brightness resistor 110, one or more LEDs 112, and a backlight control bus 113. Although backlight assembly 106 is shown to include four LEDs 112, the backlight assembly may include more or less LEDs, such as one, two, three, five, six, or more LEDs. Additionally, although backlight assembly 106 is shown to include LEDs, the backlight assembly may include lamps, fluorescent tubes, electroluminescent devices, and/or other suitable devices.

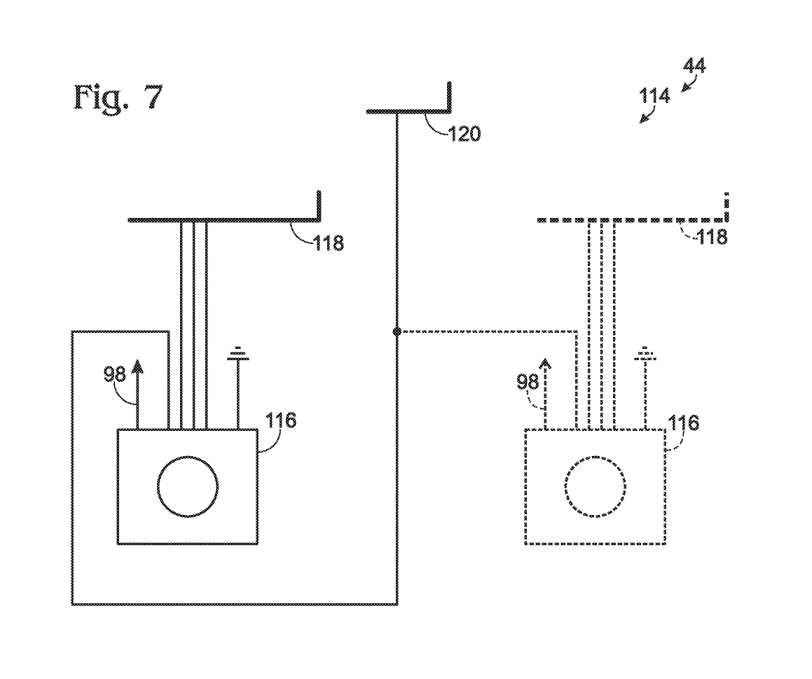

FIG. 7 shows an example of a sensor assembly 44, which is generally indicated at 114. Unless specifically excluded, sensor assembly 114 may include one or more components and/or functions of one or more other sensory assemblies described in this disclosure. Sensor assembly 114 may include one or more sensors 116, a sensor bus 118, and a clock bus 120. The sensors may be configured to detect pressure in the air spring(s) and/or air spring manifold(s). Sensor bus 118 and clock bus 120 may be connected to the processor assembly.

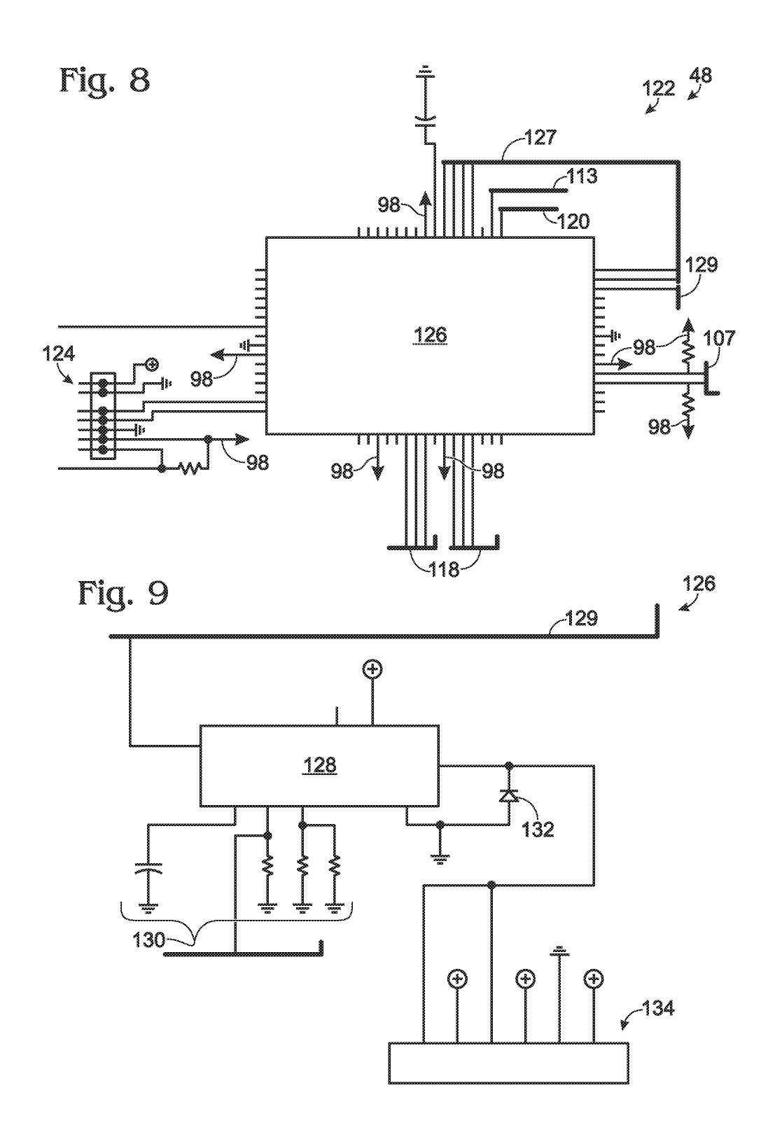

FIG. 8 shows an example of a processor assembly 48, which is generally indicated at 122. Unless specifically excluded, processor assembly 122 may include one or more components and/or functions of one or more other processor assemblies described in this disclosure. Processor assembly 122 may include a programming connector assembly 124, a system controller 126, and a keypad bus 127. The programming connector assembly may allow application software to be loaded on to the system controller. The system controller may control one or more other components of the portable load scale device, as discussed above. System controller 126 may be connected to the power supply assembly at the arrows shown in FIG. 8 and/or to the other components via various buses, such as LCD display bus 107, backlight control bus 113, sensor bus 118, and sensor clock bus 120.

FIG. 9 shows an example of a solenoid control assembly 126, which may include any suitable structure configured to drive and/or control the solenoid(s) of the solenoid valve assembly. For example, the solenoid control assembly may include a solenoid driver 128, a solenoid driver bus 129, a control assembly 130, an overvoltage protection diode 132, and a power connector assembly 134. The solenoid driver may be configured to drive and/or control the solenoid(s) and may be connected to the processor assembly via solenoid driver bus 129. Solenoid driver 128 may be configured to connect the solenoid(s) to the power source for any suitable amount of time. Control assembly 130 may be configured to set the amount of power that the solenoid(s) will receive. Power connector assembly 134 may provide physical connections to the solenoid(s) and/or power from the power supply assembly.

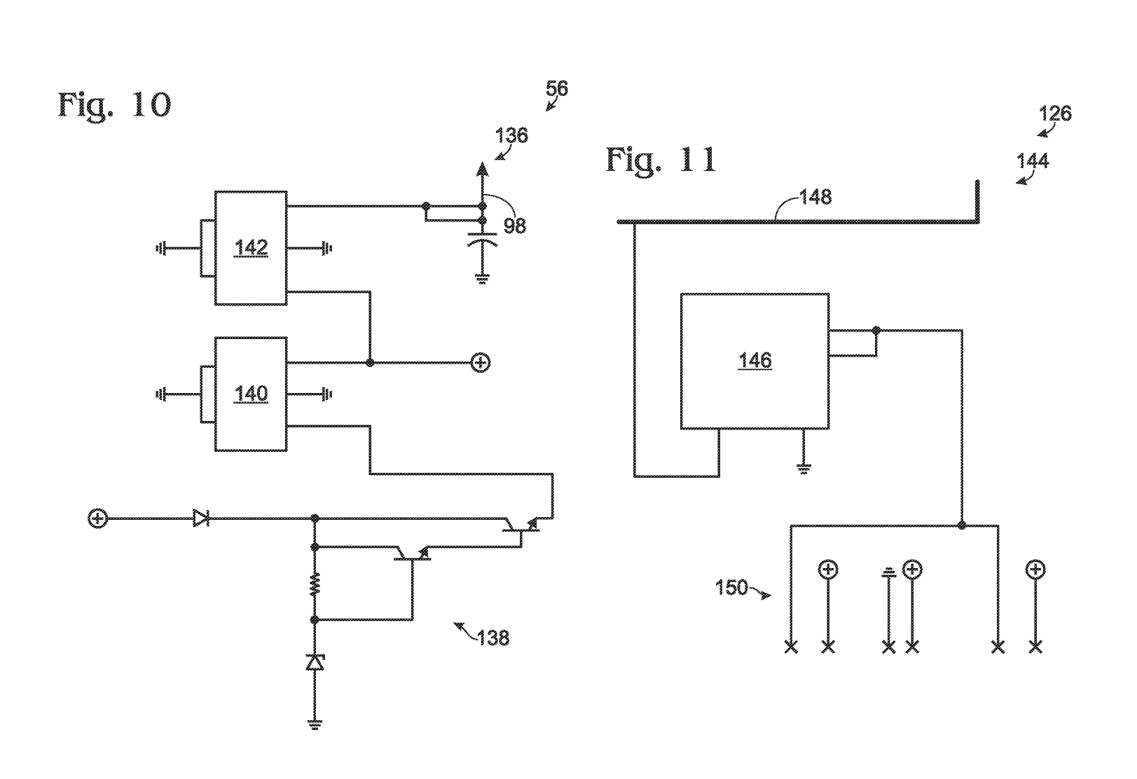

FIG. 10 shows another example of a power supply assembly 56, which is generally indicated at 136. Unless specifically excluded, power supply assembly 136 may include one or more components and/or functions of one or more other power supply assemblies described in this disclosure. Power supply assembly 136 may include a power protector assembly 138, an intermediate voltage regulator 140, and a final voltage regulator 142. The power protector assembly may, for example, be configured to provide load dump and reverse power protection. Intermediate voltage regulator 140 may receive voltage from power source 84 and regulate that voltage to an intermediate voltage, such as from about 12 volts to about 8 volts. Final voltage regulator 142 may receive the intermediate voltage and regulate that voltage to a final voltage suitable for one or more other components of the portable load scale device, such as about 3.3 volts to the processor assembly and/or display assembly.

FIG. 11 shows another example of a solenoid control assembly 126, which is generally indicated at 144. Unless specifically excluded, solenoid control assembly 126 may include one or more components and/or functions of one or more other solenoid control assemblies described in this disclosure. Solenoid control assembly 144 may include a switch assembly 146, a switch bus 148, and a power connector assembly 150. Switch assembly 146 may drive and/or control the solenoid(s) of the solenoid valve assembly and may be connected to the processor assembly via switch bus 148. Power connector assembly 150 may provide physical connections to the solenoid(s) and/or power from the power supply assembly.

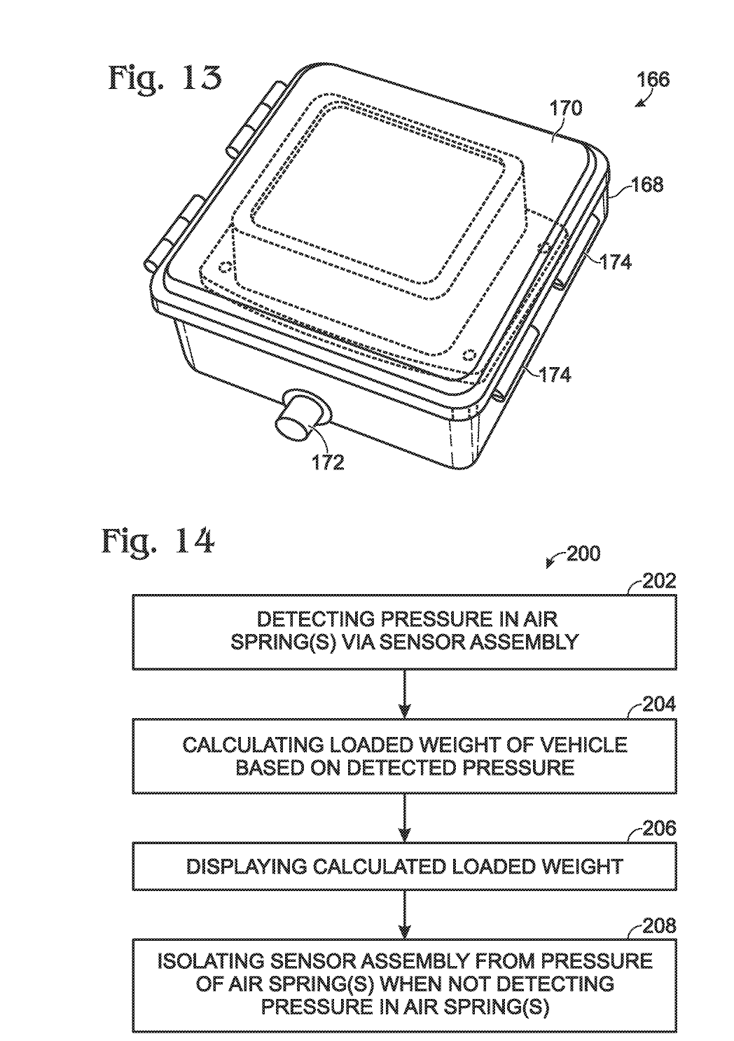

FIG. 12 shows an example of a portable load scale device 38, which is generally indicated at 152. Unless specifically excluded, portable load scale device 152 may include one or more components and/or functions of one or more other portable load scale devices described in this disclosure. Portable load scale device 152 may include a housing 153, an LCD display 154 and a keypad assembly 156. The keypad assembly may include a plurality of keys, such as a power key 158, a menu key 160, calibration keys 162, and toggle keys 164. Although keypad assembly 156 is shown to include particular keys, the keypad assembly may include any suitable keys. Additionally, although portable load scale device 152 is shown to include keypad assembly 156, the portable load scale device may include other suitable type(s) of input assemblies, such as a graphical user interface or voice activation system.

As shown in FIG. 13, portable load scale system 20 may include a protective box 166, which may include any suitable structure configured to receive portable load scale device 38. For example, the protective box may include a base 168 and a door 170. The base may be configured to receive the portable load scale device and may include a channel 172 for the cable(s) and/or tubing of the portable load scale device (such as the power cable and the tubing). Door 170 may be pivotably attached to base 168 and may include latches 174 to selectively attach to base 168. The protective box may be removably attached to the frame of the vehicle, such as shown in FIG. 1.

FIG. 14 shows a method 200 of measuring a loaded weight of a vehicle, such as vehicle 22. The method may include detecting pressure in at least one air spring via a sensor assembly of a portable load scale device, such as the sensor assemblies and portable load scale devices discussed above, at 202. Additionally, the method may include calculating a loaded weight of the vehicle based on the detected pressure, at 204. Moreover, the method may include displaying the calculated loaded weight, at 206. Furthermore, the method may include isolating the sensor assembly from the pressure of the at least one air spring when not detecting the pressure in the at least one air spring, while not isolating the at least one air spring from its pressure source, at 208.

Additionally, method 200 may include receiving power from a power source and providing power to the portable load scale device, such as providing power in a first voltage to at least a first component of portable load scale device and/or providing power in a second voltage different from the first voltage to at least a second component. Although FIG. 14 shows an example of a method for measuring a loaded weight of a vehicle, other examples may omit, add to, and/or modify any of the steps shown in that figure.

Portable load scale system 20 also may include nontransitory computer readable storage media having embodied therein a plurality of machine-readable instructions, wherein, when a processor executes the instructions, the instructions provide for one or more steps of a method for measuring a loaded weight of a vehicle, such as one or more steps of method 200.

In operation, portable load scale system 20 may be calibrated by any suitable method(s) that allow conversion of detected pressure to a corresponding loaded weight for a vehicle. For example, calibration may be accomplished by providing upper and lower pairs of air pressure-to-weight values. The processor assembly of the portable load scale device may then perform interpolation to obtain a weight corresponding to the current sensed air pressure value.

Interpolation may be accomplished by any suitable method(s). For example, if the lower calibration point consists of (1) a low calibration weight value and (2) a low calibration pressure value, while the upper calibration point consists of (3) a high calibration weight value and (4) a high calibration pressure value, the processor assembly may first calculate a slope of the line between the upper and lower calibration points by dividing the difference between the high and low calibration weights with the difference between the high and low calibration pressures. The processor assembly may then (1) multiply that slope with the difference between the current pressure and the pressure of the lower calibration point, and (2) add the value from (1) to the weight of the lower calibration point. An example of the formulas that may be used by the processor assembly in calculating a current weight (or calculated loaded weight) are provided below.

Slope=(HCW−LCW)/(HCP−LCP)

CW=(Slope*(CP−LCP))+LCW

### Terms:

CP=current pressure of the air suspension (psi)
CW=current weight (lbs)
HCP=high pressure (psi)
HCW=high weight (lbs)
LCP=low pressure (psi)
LCW=low weight (lbs) The processor assembly may use the same formula described above when the current pressure is above the high calibration pressure or below the low calibration pressure. Alternatively, the processing unit may use one or more different formulas.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein.

Applicant reserves the right to submit claims directed to certain combinations and subcombinations that are directed to one of the disclosed inventions and are believed to be novel and non-obvious. Inventions embodied in other combinations and subcombinations of features, functions, elements and/or properties may be claimed through amendment of those claims or presentation of new claims in that or a related application. Such amended or new claims, whether they are directed to a different invention or directed to the same invention, whether different, broader, narrower or equal in scope to the original claims, are also regarded as included within the subject matter of the inventions of the present disclosure. Where such claims recite “a” or “a first” element or the equivalent thereof, such claims should be understood to include incorporation of one or more such elements, neither requiring nor excluding two or more such elements.

What is claimed is:

1. A portable load scale device for a vehicle having a frame, a wheel axle assembly, a pressure source, and at least one air spring disposed between the frame and the wheel axle assembly and pressurized by the pressure source, the device comprising:
a sensor assembly configured to detect pressure in the at least one air spring;
a solenoid valve assembly disposed between the sensor assembly and the at least one air spring and configured, when the sensor assembly is not detecting the pressure, to isolate the sensor assembly from the pressure in the at least one air spring while not isolating the at least one air spring from the pressure source;
a processor assembly configured to calculate a loaded weight of the vehicle based on the detected pressure; and
a display assembly configured to display the calculated loaded weight.

2. The portable load scale device of claim 1, wherein the solenoid valve assembly includes an valve disposed between the sensor assembly and the at least one air spring, and a solenoid operatively connected to the valve to move the valve between an open position in which the sensor assembly is in fluid communication with the at least one air spring, and a closed position in which the sensor assembly is isolated from the at least one air spring.

3. The portable load scale device of claim 1, where the at least one air spring includes first and second air springs, and wherein the solenoid valve assembly includes first and second valves and first and second solenoids, the first and second valves being disposed between the sensor assembly and the first and second air springs, respectively, and the first and second solenoids being operatively connected to the first and second valves, respectively, to move the first and second valves between open and closed positions.

4. The portable load scale device of claim 3, wherein the sensor assembly includes first and second sensors, the first sensor being configured to detect pressure in the first air spring, and the second sensor being configured to detect pressure in the second air spring.

5. The portable load scale device of claim 4, wherein the processor is configured to calculate the loaded weight of the vehicle based on the pressure detected by the first and second sensors.

6. The portable load scale device of claim 5, wherein the processor is configured to calculate a first loaded weight based on the pressure detected by the first sensor, a second loaded weight based on the pressure detected by the second sensor, and at least one of an average loaded weight based on the first and second loaded weights and a sum of the first and second loaded weights.

7. The portable load scale device of claim 1, wherein the sensor assembly includes a sensor configured to detect the pressure in the at least one air spring and produce an analog output voltage.

8. The portable load scale device of claim 7, wherein the sensor assembly includes a sensor processor configured to convert the analog output voltage into a digital value.

9. The portable load scale device of claim 1, where the vehicle includes a power source, further comprising a power supply assembly configured to receive power from the power source and provide that power to one or more other components of the portable load scale device.

10. The portable load scale device of claim 9, wherein the power supply assembly in configured to provide power in a first voltage to the solenoid valve assembly, and to provide power in a second voltage different from the first voltage to at least one of the processor assembly and the display assembly.

11. A portable load scale device for a vehicle having a frame, a wheel axle assembly, a pressure source, and at least one air spring disposed between the frame and the wheel axle assembly and pressurized by the pressure source, the device comprising:
a housing configured to be removably mounted to the frame;
a sensor assembly contained within the housing and configured to detect pressure in the at least one air spring;
a solenoid valve assembly contained within the housing and disposed between the sensor assembly and the at least one air spring, the solenoid valve assembly being configured, when the sensor assembly is not detecting the pressure, to isolate the sensor assembly from the pressure in the at least one air spring;
a processor assembly contained within the housing and configured to calculate a loaded weight of the vehicle based on the detected pressure; and
a display assembly configured to display the calculated load weight.

12. The portable load scale device of claim 11, wherein the display assembly is contained within the housing.

13. The portable load scale device of claim 11, wherein the solenoid valve assembly is configured, when the sensor assembly is not detecting the pressure, to isolate the sensor assembly from the pressure in the at least one air spring while not isolating the at least one air spring from the pressure source.

14. The portable load scale device of claim 11, further comprising a protective box configured to receive the housing and to be mounted on the frame of the vehicle.

15. The portable load scale device of claim 11, where the vehicle further includes a power source, further comprising a power supply assembly configured to receive power from the power source and provide power in a first voltage to the solenoid valve assembly, and to provide power in a second voltage different from the first voltage to at least one of the processor assembly and the display assembly.

16. The portable load scale device of claim 15, wherein the power source is a vehicle battery, and the power supply assembly is configured to receive power from the vehicle battery.

17. A method of measuring a loaded weight of a vehicle having a frame, a wheel axle assembly, a pressure source, and at least one air spring disposed between the frame and the wheel axle assembly and pressurized by the pressure source, the method comprising:
detecting pressure in the at least one air spring via a sensor assembly of a portable load scale device;
calculating loaded weight of the vehicle based on the detected pressure;
displaying the calculated loaded weight; and
isolating the sensor assembly from the pressure in the at least one air spring when not detecting the pressure in the at least one air spring, while not isolating the at least one air spring from the pressure source.

18. The method of measuring a loaded weight of a vehicle of claim 17, where the vehicle includes a power source, further comprising receiving power from the power source and providing the power to the portable load scale device.

19. The method of measuring a loaded weight of a vehicle of claim 18, where the portable load scale device includes at least a first component and a second component different from the first component, wherein providing the power to the portable load scale device includes providing power in a first voltage to at least the first component.

20. The method measuring a loaded weight of a vehicle of claim 19, wherein providing the power to the portable load scale device further includes providing power in a second voltage different from the first voltage to at least the second component.
